(19) United States
(12) Patent Application Publication
(10) Pub. No.: US 2025/0349949 A1
(43) Pub. Date: Nov. 13, 2025

(54) APPARATUS AND METHOD OF CONTROLLING BATTERY CELL ENCLOSURE POTENTIAL

(71) Applicant: GM GLOBAL TECHNOLOGY OPERATIONS LLC, Detroit, MI (US)

(72) Inventors: Matthew Arthur Celentano, Berkley, MI (US); Seung-woo Chu, Sterling Heights, MI (US)

(73) Assignee: GM GLOBAL TECHNOLOGY OPERATIONS LLC, Detroit, MI (US)

(21) Appl. No.: 18/658,941

(22) Filed: May 8, 2024

(51) Int. Cl. H01M 50/172; H01M 10/04; H01M 10/0525; H01M 50/159; H01M 50/593

(52) U.S. Cl. CPC H01M 50/172; H01M 10/04; H01M 50/159; H01M 50/593; H01M 10/0525

(57) ABSTRACT

Disclosed is a product that may including a lithium-ion battery cap plate comprising a metal, and an electrically conductive pathway component in electrical contact with the lithium-ion battery cap plate, wherein electrically conductive pathway component may be slightly or sufficiently conductive to allow charge transfer between the terminal and the cap plate to provide electrochemical stability to the cap plate.

### INTRODUCTION

The technical field generally relates to batteries, compartments thereof, and methods of using the same.

Batteries have heretofore been made using a thermoplastic as an insulation layer between a terminal and a cell closure.

It is desirable to make an insulation layer between a terminal and a cell from a material including additional components or alternative components to a thermoplastic. Furthermore, other desirable features and characteristics of the variations disclosed herein will become apparent from the subsequent detailed description and the appended claims, taken in conjunction with the accompanying drawings and the foregoing.

### SUMMARY

A number of variations may include a product including: a lithium-ion battery cap plate including a metal; and an electrically conductive pathway component in electrical contact with the lithium-ion battery cap plate, wherein electrically conductive pathway component may be slightly or sufficiently conductive to allow charge transfer between the terminal and the cap plate to provide electrochemical stability to the cap plate.

A number of variations may include a product wherein the electrically conductive pathway component including a first polymeric material and an electrically conductive filler.

A number of variations may include a product wherein the electrically conductive pathway component includes an electrically conductive tape having an adhesive layer and a backing layer, and wherein the backing layer includes a first polymeric material and an electrically conductive filler.

A number of variations may include a product wherein the electrically conductive pathway component is received in an electrical insulation portion of an internal insert, wherein the electrical insulation portion includes a second polymeric material that is not electrically conductive.

A number of variations may include a product wherein the electrically conductive pathway component includes a first through hole sized, constructed and arranged to receive at least one of a first terminal or a first weld plate, and wherein the electrical insulation portion includes a first through hole sized, constructed and arranged to receive at least one of the first terminal or the first weld plate.

A number of variations may include a product wherein the electrical insulation portion includes a second through hole sized, constructed and arranged to receive at least one of a second terminal or a second weld plate.

A number of variations may include a product further including at least one lithium-ion battery cell having at least a first electrode having a first electrode tab, and wherein the electrically conductive pathway component is electrically connected to the first electrode tab so that the lithium-ion battery cap plate is electrochemically stable.

A number of variations may include a product further including a first terminal extending through the lithium-ion battery cap plate.

A number of variations may include a product further including insulation material electrically isolating the first terminal from the lithium-ion battery cap plate.

A number of variations may include a product further including a first weld plate welded to the first terminal and the first electrode tab.

A number of variations may include a product further including at least one lithium-ion battery cell having at least a first electrode having a first electrode tab, and wherein electrically conductive pathway component may be slightly or sufficiently conductive to allow charge transfer between the terminal and the cap plate to provide electrochemical stability to the cap plate.

A number of variations may include a product including: a lithium-ion battery including a plurality of battery cells, wherein each battery cell includes a first electrode and a second electrode, and a separator between the first electrode and the second electrode, and wherein the first electrode includes a first electrode tab; a lithium-ion battery cap plate including a metal; and electrically conductive pathway component in electrical contact with the lithium-ion battery cap plate and the first electrode tab, wherein electrically conductive pathway component may be slightly or sufficiently conductive to allow charge transfer between the terminal and the cap plate to provide electrochemical stability to the cap plate.

A number of variations may include a method including: electrically connecting a lithium-ion battery cap plate including a metal to an electrically conductive pathway component, wherein the electrically conductive pathway component so that the lithium-ion battery cap plate is electrochemically stable.

A number of variations may include a method wherein the electrically conductive pathway component includes a first polymeric material and an electrically conductive filler.

A number of variations may include a method wherein the electrically conductive pathway component includes an electrically conductive tape having an adhesive layer and a backing layer, and wherein the backing layer includes a first polymeric material and an electrically conductive filler.

A number of variations may include a method wherein the electrically conductive pathway component is received in an electrical insulation portion of an internal insert, wherein the electrical insulation portion includes a second polymeric material that is not electrically conductive.

A number of variations may include a method further including forming the internal insert using a two shot injection molding method including forming the electrically conductive pathway component by injecting a flowable first polymeric material and an electrically conductive filler into a first mold and solidifying the flowable first polymeric material to form the electrically conductive pathway component, keeping the electrically conductive pathway component in the first mold or moving the electrically conductive pathway component to a second mold, and forming the electrical insulation portion by injecting a flowable second polymeric material into the first mold or the second mold, and solidifying the flowable second polymeric material so that the electrically conductive pathway component and the electrical insulation portion are at least one of physically or chemically bonded together.

A number of variations may include a method further including forming the internal insert using a two shot injection molding method including forming the electrical insulation portion by injecting a flowable second polymeric material into a first mold, and solidifying the flowable second polymeric material to form the electrical insulation portion, keeping the electrical insulation portion in the first mold or moving the electrical insulation portion to a second mold, forming the electrically conductive pathway component by injecting a flowable first polymeric material and an electrically conductive filler into the first mold or the second mold, and solidifying the flowable first polymeric material to form the electrically conductive pathway component and so that the electrically conductive pathway component and the electrical insulation portion are at least one of physically or chemically bonded together.

A number of variations may include a method wherein electrically connecting the lithium-ion battery cap plate to the electrically conductive pathway component including adhering the electrically conductive tape to a first terminal and the lithium-ion battery cap plate.

A number of variations may include a method further including electrically connecting the first terminal to a first electrode tab of a first electrode of a lithium-ion battery cell is semiconducting so that the lithium-ion battery cap plate is electrochemically stable.

### BRIEF DESCRIPTION OF THE DRAWINGS

The variations will hereinafter be described in conjunction with the following drawing figures, wherein like numerals denote like elements, and wherein:

FIG. 1 is a perspective, schematic illustration of select components of a lithium-ion battery and method according to a number of variations;

FIG. is a perspective, schematic illustration of select components of a lithium-ion battery and method according to a number of variations;

FIG. 3 is a perspective view of select components of a lithium-ion battery, with portions removed, according to a number of variations;

FIG. 4 is a schematic illustration of a lithium-ion battery according to a number of variations;

FIG. 5 is a schematic illustration of an electrically conduct pathway component having a polymeric material and electrically conductive filler according to a number of variations;

FIG. 6 is a schematic illustration of a portion of a lithium-ion battery according to a number of variations;

FIG. 7 is a schematic illustration of an electrically conduct pathway component including a tape having an adhesive layer and a backing layer including a polymeric material and electrically conductive filler according to a number of variations;

FIG. 8, is a schematic illustration of a lithium-ion battery wherein a electrically conductive pathway is provided in a first electrical insulation layer and contacts the cap plate and the first terminal and/or the first weld plate according to a number of variations; and

FIG. 9 is sectional, top view of the electrically conductive pathway provided in the first electrical insulation layer 124 and contacting the second terminal.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

The following detailed description is merely illustrative in nature and is not intended to limit the application and uses. Furthermore, there is no intention to be bound by any expressed or implied theory presented in the preceding technical field, background, brief summary or the following detailed description.

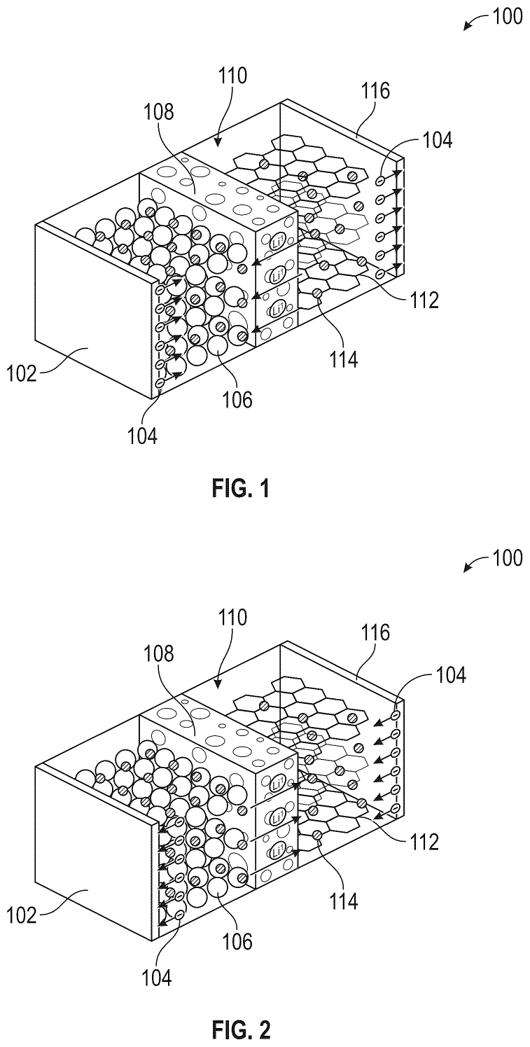

FIGS. 1 and 2 illustrate a product which may be a lithium-ion battery and methods of discharging and charging according to a number of variations. The product 100 may include a first electrode 102, for example a cathode, and a first active material 106 on or adjacent to the first electrode 102. For a cathode electrode, the first active material 106 may be deposited on the first electrode 102 with a composition including metal oxides as the active material along with one or more conductive additives and one or more binders. The first active material 106 may include, but not limited to, at least one of lithium cobalt oxide (LiCoO2), lithium manganese oxide (LiMn2O4), lithium iron phosphate (LiFePO4 or LFP), or lithium nickel manganese cobalt oxide (LiNiMnCoO2 or NMC). A second electrode 116, for example an anode, may be provided and a second active material 112 may be deposited on the second electrode 116. The second active material 112 may include, but not limited to, at least one of carbon-based materials such as graphite, silicon, or a combination of both, or lithium metal carbon materials. A separator 108 may be provided between the first electrode 102 and the second electrode 116 and may be constructed and arranged to allow the movement of lithium ions therethrough. The product 100 may also include an electrolyte 110. The electrolyte 110 may include, but not limited to, at least one of LiPF6, LiBF4, or LiClO4, in an organic solvent.

Referring again to FIG. 1, while the product 100 (battery) is discharging and providing an electric current, for example to power an electric motor in a vehicle, the second electrode 116 (anode) or the second active material 112 releases lithium ions 114 to the first electrode 102 (cathode) or first active material 106, generating a flow of electrons 104 from second electrode 116 (anode) to the first electrode 102 (cathode). Referring again to FIG. 2, when plugging in the product 100 (battery) to a source of electric current, the opposite happens, so that lithium ions 114 are released by the first electrode 102 (cathode) or first active material 106 and are received by the second electrode 116 (anode) of second active material 112.

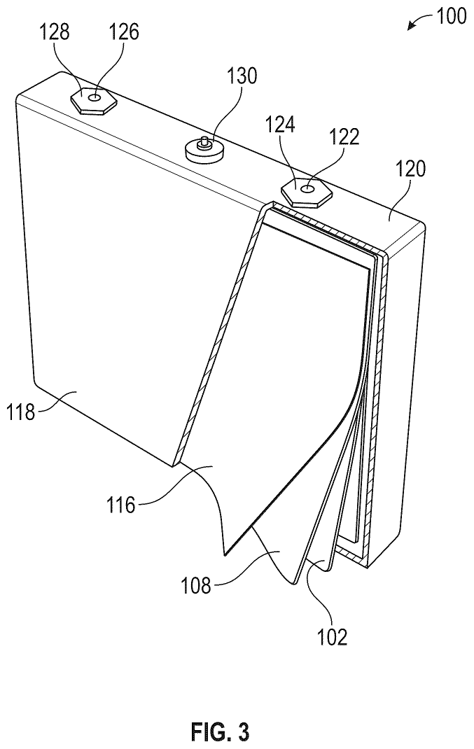

FIG. 3 illustrates a product 100 which may be a battery and may include a cell 300 which may include the first electrode 102 (cathode) and the second electrode 116 (anode) and the separator 108 therebetween. A plurality of cells 300 may be housed in an enclosure 118 which may be made from a material including a metal, such as but not limited to, aluminum or steel. A cap plate 120 may be provided as part of the enclosure 118 or as a separate piece. The first terminal 122 may extend through the cap plate 120 and may be electrically isolated from the cap plate 120 by a first electrical insulation material 124. The second terminal 126 may extend through the cap plate 120 and may be electrically isolated from the cap plate 120 by a second electrical insulation material 128. A pressure relief vent or electrolyte light injection port 130 may be provided in the cap plate 120.

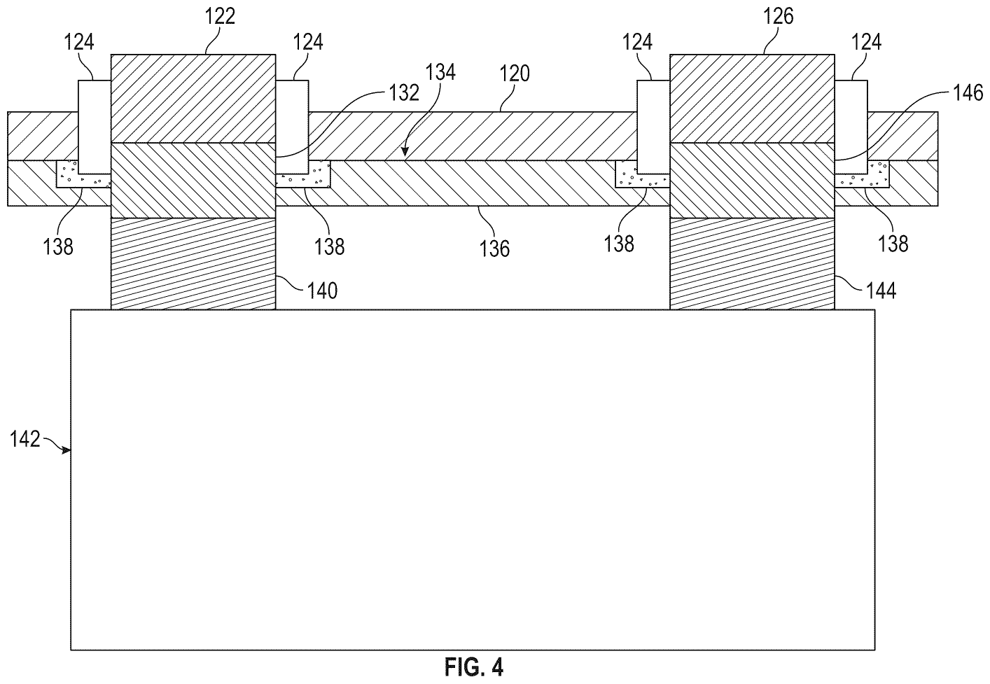

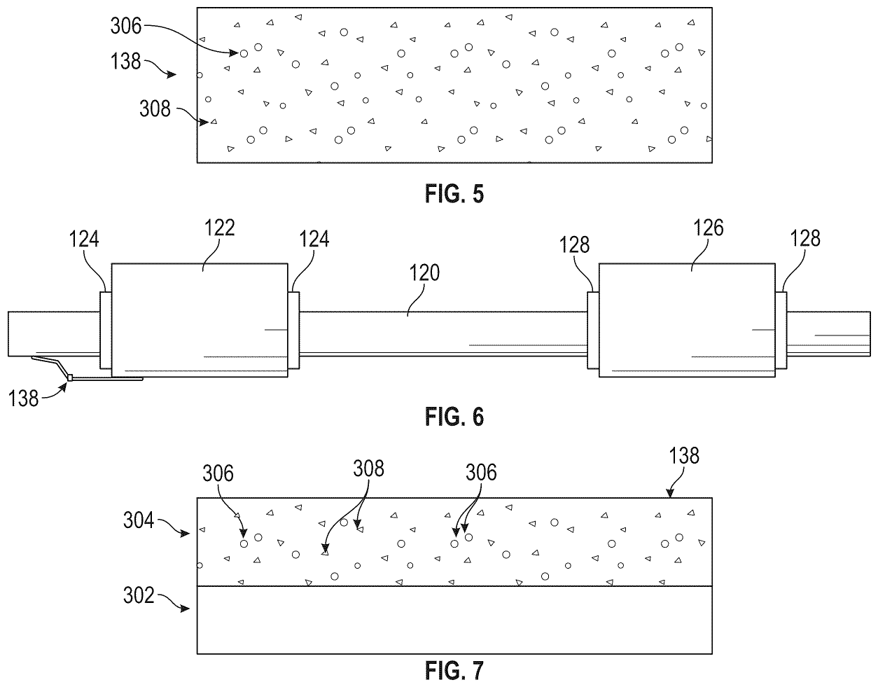

A number of variations are illustrated in FIGS. 3-5, which may include an electrode stack 142 which may include a plurality of cells 300 (illustrated in FIG. 3), wherein the first electrode 102 may include a first electrode tab 140, which may be a cathode tab, and wherein the second electrode 116 may include a second electrode tab 144, which may be an anode tab. The first terminal 122 may be connected to the first electrode tab 140 directly or indirectly, for example by a first weld plate 132 while the to the first terminal 122 and the first electrode tab 140. The second terminal 126 may be connected to the second electrode tab 144 directly or indirectly, for example by a second weld plate 146. Again, the first electrode 102 may be electrically isolated from the cap plate 120 by a first electrical insulation material 124 and the second terminal 126 may be electrically isolated from the cap plate 120 by a second electrical insulation material 128. An internal insert 134 may be provided including an electrical insulation portion 136 which does not conduct electricity (i.e., is not electrically conductive). The internal insert 134 may also include an electrically conductive pathway component 138 which may include a polymeric material 306 and an electrically conductive filler 308 (illustrated in FIG. 5). As shown in FIG. 4, the electrically conductive pathway component 138 may be positioned to provide an electrical connection to the first electrode tab 140 and to the cap plate 120. In a number of variations, the electrically conductive pathway component 138 may directly contact the cap plate 120. In a number of variations, the electrical insulation portion 136 may include a first through hole 312 and the electrically conductive pathway component 138 may include a first through hole 310 and both through holes 310, 312 may be sized, constructed and arranged to receive at least one of the first terminal 122 or the first weld plate 132. The electrical insulation portion 136 may include a second through hole 314 sized, constructed and arranged to receive at least one of the second terminal 126 or the second weld plate 146. The polymeric material 306 and the amount of electrically conductive filler 308 in the electrically conductive pathway component 138 is sufficient to allow electrical current to flow from the first electrode tab 140 to the cap plate 120 to make the cap plate 120 electrochemically stable and not subject to erosion or degradation by the electrolyte in the product 100 (battery). In a number of variations, making the cap plate 120 electrochemically stable may cause a passion layer to grow on the cap plate 120. In a number of variations, a passivation layer which may include AlF₃ may grow on the cap plate 120. In a number of variations, the electrically conductive filler may include at least one of glass, metal, or carbon. In a number of variations, the electrically conductive filler 308 may include fiberglass, glass particles, metal fibers or metal particles. In a number of variations, the electrical insulation portion 136 of the internal insert 34 may include, but is not limited to, polyphenylene sulfide (PPS). In a number of variations, the electrically conductive pathway component 138 of the internal insert 34 may include, but is not limited to, polyphenylene sulfide (PPS). In a number of variations, the electrically conductive filler 308 may be present an amount ranging from about 5% to about 70% by weight of a polymeric material 306. In a number of variations, the electrically conductive filler 308 may be present an amount ranging from about 25% to about 35%, by weight of a polymeric material 306. In a number of variations, the electrically conductive filler 308 may be present an amount of about 30%, by weight of a polymeric material 306. In a number of variations, the electrically conductive pathway component may be slightly or sufficiently conductive to allow charge transfer between the terminal and the cap plate to provide electrochemical stability to the cap plate. In a number of variations, the electrically conductive pathway component may include a polymeric material and a sufficient amount of a filler so that the electrically conductive pathway component may have a conductivity ranging from 10-10-103 Siemens per meter (S/m). In a number of variations, the electrically conductive pathway component may be semiconducting.

Alternatively, in a number of variations, as will be appreciated from FIGS. 4 and 6, the electrically conductive pathway component 138 may be positioned to provided an electrical connection with the second electrode tab 144 (FIG. 4) or an electrical connection to the second terminal 126 (FIG. 6).

In a number of variations, the electrically conductive pathway component 138 and the electrical insulation portion 136 may be separate pieces. In a number of variations, the internal insert 134 may be made using a method including two shot injection molding which may include injecting a first material for the electrical insulation portion 136 into a first injection mold and solidified the first material, and thereafter injecting a second material for the electrically conductive pathway component 138 into the first injection mold or into a second injection mold into which the solidified first material has been placed. Alternatively, the steps may be reversed wherein in a first step injecting a second material for the electrically conductive pathway component 138 into the first mold and solidifying the second material, and thereafter injecting the first material for the electric insulation portion al into the first mold or into a second mold into which the solidified second material has been placed.

FIG. 5 is a schematic illustration which may include cap plate 120 having the first terminal 122 extending through the cap plate 120 and a first electrical insulation material 124 electrically isolating the first terminal 122 from the cap plate 120, and a second terminal 126 extending through the cap plate 120 and a second electrical insulation material 128 electrically isolating the second terminal 126 from the cap plate 120. An electrically conductive pathway component 138 may be provided from the first terminal 122 to the cap plate 120. In a number of variations, the electrically conductive pathway component 138 may include an electrically conductive tape. In a number of variations, for example as shown in FIG. 6, but not limited to, the electrically conductive tape may include any adhesive layer 302 and a backing layer 304 including a polymeric material 306 and an electrically conductive filler 308. As can be appreciated from FIGS. 5-7, a number of other variations may include the electrically conductive pathway component 138 being an electrically conductive tape (for example as illustrated in FIG. 7) adhered to the first terminal 122 and the cap plate 120, and the first weld plate 132 welded to the first terminal 122 and the first electrode tab 140 of an electrode of a lithium-ion battery cell.

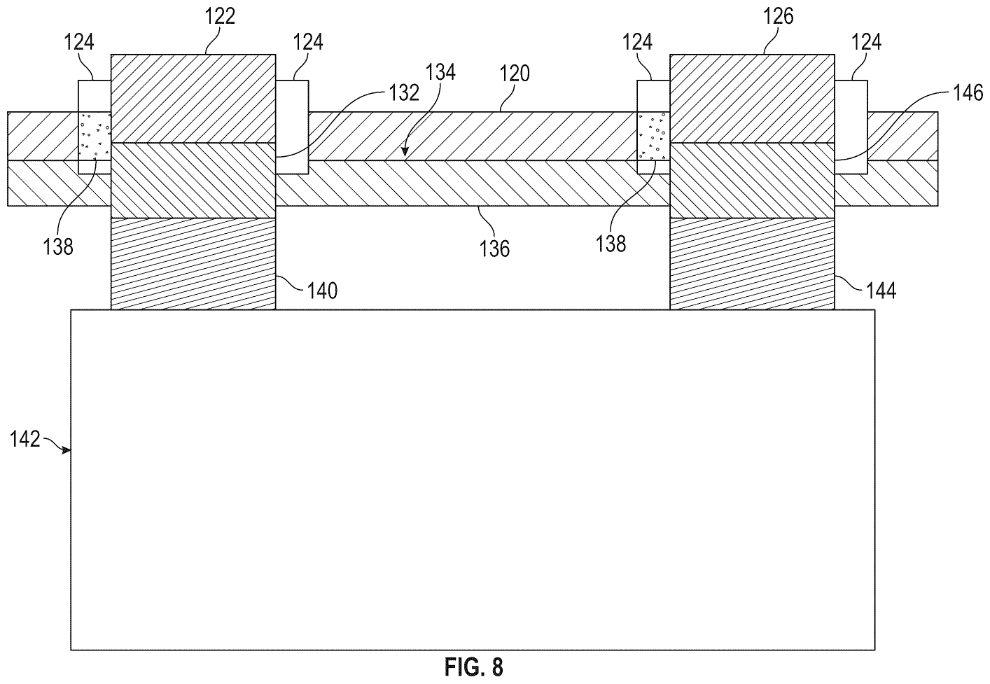

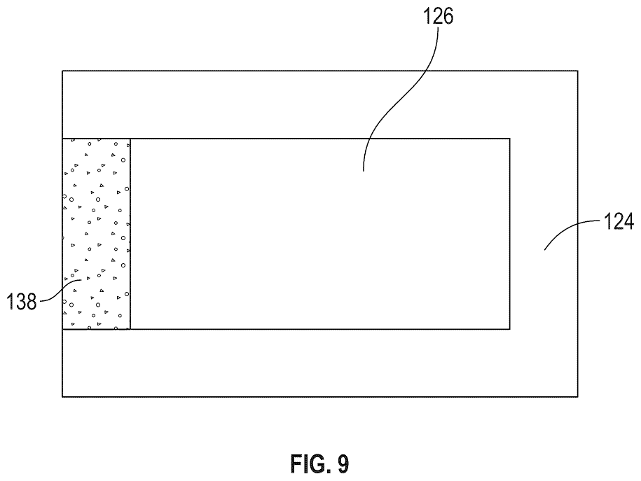

A number of variations are illustrated in FIG. 8, the wherein the electrically conductive pathway 138 may be provided in the first electrical insulation layer 124 and may contact the cap plate 120 and the first terminal 122 and/or the first weld plate 132, or the second terminal 126 and/or the second weld plate 146. FIG. 9 is sectional, top view of the electrically conductive pathway 138 which may be provided in the first electrical insulation layer 124 and contact the second terminal 126.
Clause 1. A product comprising: a lithium-ion battery cap plate comprising a metal; and an electrically conductive pathway component in electrical contact with the lithium-ion battery cap plate, wherein electrically conductive pathway component may be slightly or sufficiently conductive to allow charge transfer between the terminal and the cap plate to provide electrochemical stability to the cap plate.
Clause 2. The product as set forth in clause 1 wherein the electrically conductive pathway component comprising a first polymeric material and an electrically conductive filler.
Clause 3. The product as set forth in clause 1 wherein the electrically conductive pathway component comprises an electrically conductive tape having an adhesive layer and a backing layer, and wherein the backing layer includes a first polymeric material and an electrically conductive filler.
Clause 4. The product as set in clause 1 wherein the electrically conductive pathway component is received in an electrical insulation portion of an internal insert, wherein the electrical insulation portion includes a second polymeric material that is not electrically conductive.
Clause 5. The product as set forth in clause 4 wherein the electrically conductive pathway component includes a first through hole sized, constructed and arranged to receive at least one of a first terminal or a first weld plate, and wherein the electrical insulation portion includes a first through hole sized, constructed and arranged to receive at least one of the first terminal or the first weld plate.
Clause 6. The product as set forth in clause 5 wherein the electrical insulation portion includes a second through hole sized, constructed and arranged to receive at least one of a second terminal or a second weld plate.
Clause 7. The product is set forth in clause 1 further comprising at least one lithium-ion battery cell having at least a first electrode having a first electrode tab, and wherein the electrically conductive pathway component is electrically connected to the first electrode tab so that the lithium-ion battery cap plate is electrochemically stable.
Clause 8. The product as set forth in clause 7 further comprising a first terminal extending through the lithium-ion battery cap plate.
Clause 9. The product is set forth in clause 8 further comprising insulation material electrically isolating the first terminal from the lithium-ion battery cap plate.
Clause 10. The product as set forth in clause 8 further comprising a first weld plate welded to the first terminal and the first electrode tab.
Clause 11. The product is set forth in clause 3 further comprising at least one lithium-ion battery cell having at least a first electrode having a first electrode tab, and wherein electrically conductive pathway component may be slightly or sufficiently conductive to allow charge transfer between the terminal and the cap plate to provide electrochemical stability to the cap plate.
Clause 12. A product comprising: a lithium-ion battery comprising a plurality of battery cells, wherein each battery cell includes a first electrode and a second electrode, and a separator between the first electrode and the second electrode, and wherein the first electrode includes a first electrode tab; a lithium-ion battery cap plate comprising a metal; and electrically conductive pathway component in electrical contact with the lithium-ion battery cap plate and the first electrode tab, wherein electrically conductive pathway component may be slightly or sufficiently conductive to allow charge transfer between the terminal and the cap plate to provide electrochemical stability to the cap plate.
Clause 13. A method comprising: electrically connecting a lithium-ion battery cap plate comprising a metal to an electrically conductive pathway component, wherein the electrically conductive pathway component so that the lithium-ion battery cap plate is electrochemically stable.
Clause 14. The method as set forth in clause 13 wherein the electrically conductive pathway component comprises a first polymeric material and an electrically conductive filler.
Clause 15. The method as set forth in clause 13 wherein the electrically conductive pathway component comprises an electrically conductive tape having an adhesive layer and a backing layer, and wherein the backing layer includes a first polymeric material and an electrically conductive filler.
Clause 16. The method as set in clause 13 wherein the electrically conductive pathway component is received in an electrical insulation portion of an internal insert, wherein the electrical insulation portion includes a second polymeric material that is not electrically conductive.
Clause 17. The method as set forth in clause 16 further comprising forming the internal insert using a two shot injection molding method including forming the electrically conductive pathway component by injecting a flowable first polymeric material and an electrically conductive filler into a first mold and solidifying the flowable first polymeric material to form the electrically conductive pathway component, keeping the electrically conductive pathway component in the first mold or moving the electrically conductive pathway component to a second mold, and forming the electrical insulation portion by injecting a flowable second polymeric material into the first mold or the second mold, and solidifying the flowable second polymeric material so that the electrically conductive pathway component and the electrical insulation portion are at least one of physically or chemically bonded together.
Clause 18. The method as set forth in clause 16 further comprising forming the internal insert using a two shot injection molding method comprising forming the electrical insulation portion by injecting a flowable second polymeric material into a first mold, and solidifying the flowable second polymeric material to form the electrical insulation portion, keeping the electrical insulation portion in the first mold or moving the electrical insulation portion to a second mold, forming the electrically conductive pathway component by injecting a flowable first polymeric material and an electrically conductive filler into the first mold or the second mold, and solidifying the flowable first polymeric material to form the electrically conductive pathway component and so that the electrically conductive pathway component and the electrical insulation portion are at least one of physically or chemically bonded together.
Clause 19. The method as set forth in clause 15 wherein electrically connecting the lithium-ion battery cap plate to the electrically conductive pathway component comprising adhering the electrically conductive tape to a first terminal and the lithium-ion battery cap plate.
Clause 20. The method as set forth in clause 19 further comprising electrically connecting the first terminal to a first electrode tab of a first electrode of a lithium-ion battery cell is semiconducting so that the lithium-ion battery cap plate is electrochemically stable.

While at least illustrative variation has been presented in the foregoing detailed description, it should be appreciated that a vast number of variations exist. It should also be appreciated that a variation or variations are only examples, and are not intended to limit the scope, applicability, or configuration of the disclosure in any way. Rather, the foregoing detailed description will provide those skilled in the art with a convenient road map for implementing the variation or variations. It should be understood that various changes can be made in the function and arrangement of elements without departing from the scope of the disclosure as set forth in the appended claims and the legal equivalents thereof.

What is claimed is:

1. A product comprising:
a lithium-ion battery cap plate comprising a metal; and
an electrically conductive pathway component in electrical contact with the lithium-ion battery cap plate, wherein electrically conductive pathway component may be slightly or sufficiently conductive to allow charge transfer between the terminal and the cap plate to provide electrochemical stability to the cap plate.

2. The product as set forth in claim 1 wherein the electrically conductive pathway component comprising a first polymeric material and an electrically conductive filler.

3. The product as set forth in claim 1 wherein the electrically conductive pathway component comprises an electrically conductive tape having an adhesive layer and a backing layer, and wherein the backing layer includes a first polymeric material and an electrically conductive filler.

4. The product as set in claim 1 wherein the electrically conductive pathway component is received in an electrical insulation portion of an internal insert, wherein the electrical insulation portion includes a second polymeric material that is not electrically conductive.

5. The product as set forth in claim 4 wherein the electrically conductive pathway component includes a first through hole sized, constructed and arranged to receive at least one of a first terminal or a first weld plate, and wherein the electrical insulation portion includes a first through hole sized, constructed and arranged to receive at least one of the first terminal or the first weld plate.

6. The product as set forth in claim 5 wherein the electrical insulation portion includes a second through hole sized, constructed and arranged to receive at least one of a second terminal or a second weld plate.

7. The product is set forth in claim 1 further comprising at least one lithium-ion battery cell having at least a first electrode having a first electrode tab, and wherein the electrically conductive pathway component is electrically connected to the first electrode tab so that the lithium-ion battery cap plate is electrochemically stable.

8. The product as set forth in claim 7 further comprising a first terminal extending through the lithium-ion battery cap plate.

9. The product is set forth in claim 8 further comprising insulation material electrically isolating the first terminal from the lithium-ion battery cap plate.

10. The product as set forth in claim 8 further comprising a first weld plate welded to the first terminal and the first electrode tab.

11. The product is set forth in claim 3 further comprising at least one lithium-ion battery cell having at least a first electrode having a first electrode tab, and wherein electrically conductive pathway component may be slightly or sufficiently conductive to allow charge transfer between the terminal and the cap plate to provide electrochemical stability to the cap plate.

12. A product comprising:
a lithium-ion battery comprising a plurality of battery cells, wherein each battery cell includes a first electrode and a second electrode, and a separator between the first electrode and the second electrode, and wherein the first electrode includes a first electrode tab;
a lithium-ion battery cap plate comprising a metal; and
electrically conductive pathway component in electrical contact with the lithium-ion battery cap plate and the first electrode tab, wherein electrically conductive pathway component may be slightly or sufficiently conductive to allow charge transfer between the terminal and the cap plate to provide electrochemical stability to the cap plate.

13. A method comprising:
electrically connecting a lithium-ion battery cap plate comprising a metal to an electrically conductive pathway component, wherein the electrically conductive pathway component is semiconducting so that the lithium-ion battery cap plate is electrochemically stable.

14. The method as set forth in claim 13 wherein the electrically conductive pathway component comprises a first polymeric material and an electrically conductive filler.

15. The method as set forth in claim 13 wherein the electrically conductive pathway component comprises an electrically conductive tape having an adhesive layer and a backing layer, and wherein the backing layer includes a first polymeric material and an electrically conductive filler.

16. The method as set in claim 13 wherein the electrically conductive pathway component is received in an electrical insulation portion of an internal insert, wherein the electrical insulation portion includes a second polymeric material that is not electrically conductive.

17. The method as set forth in claim 16 further comprising forming the internal insert using a two shot injection molding method including forming the electrically conductive pathway component by injecting a flowable first polymeric material and an electrically conductive filler into a first mold and solidifying the flowable first polymeric material to form the electrically conductive pathway component, keeping the electrically conductive pathway component in the first mold or moving the electrically conductive pathway component to a second mold, and forming the electrical insulation portion by injecting a flowable second polymeric material into the first mold or the second mold, and solidifying the flowable second polymeric material so that the electrically conductive pathway component and the electrical insulation portion are at least one of physically or chemically bonded together.

18. The method as set forth in claim 16 further comprising forming the internal insert using a two shot injection molding method comprising forming the electrical insulation portion by injecting a flowable second polymeric material into a first mold, and solidifying the flowable second polymeric material to form the electrical insulation portion, keeping the electrical insulation portion in the first mold or moving the electrical insulation portion to a second mold, forming the electrically conductive pathway component by injecting a flowable first polymeric material and an electrically conductive filler into the first mold or the second mold, and solidifying the flowable first polymeric material to form the electrically conductive pathway component and so that the electrically conductive pathway component and the electrical insulation portion are at least one of physically or chemically bonded together.

19. The method as set forth in claim 15 wherein electrically connecting the lithium-ion battery cap plate to the electrically conductive pathway component comprising adhering the electrically conductive tape to a first terminal and the lithium-ion battery cap plate.

20. The method as set forth in claim 19 further comprising electrically connecting the first terminal to a first electrode tab of a first electrode of a lithium-ion battery cell so that the lithium-ion battery cap plate is electrochemically stable.
